(19) United States
(12) Patent Application Publication
(10) Pub. No.: US 2026/0229627 A1
(43) Pub. Date: Aug. 6, 2026

(54) METHOD FOR RECOVERING MATERIALS FROM BATTERIES

(71) Applicants: HYUNDAI MOTOR COMPANY, Seoul (KR); KIA CORPORATION, Seoul (KR); UIF (University Industry Foundation), Yonsei University, Seoul (KR)

(72) Inventors: Jinyong Shim, Hwaseong-si (KR); Jae Eun Jin, Hwaseong-si (KR); Ju Heon Lee, Seoul (KR); Il Sohn, Seoul (KR); Sanghoon Lee, Seoul (KR)

(73) Assignees: HYUNDAI MOTOR COMPANY, Seoul (KR); KIA CORPORATION, Seoul (KR); UIF (University Industry Foundation), Yonsei University, Seoul (KR)

(21) Appl. No.: 19/201,904

(22) Filed: May 7, 2025

(30) Foreign Application Priority Data
Jan. 14, 2025 (KR) 10-2025-0005119

(51) Int. Cl. H01M 10/54; C22B 1/02; C22B 7/00; H01M 10/0525

(52) U.S. Cl. CPC H01M 10/54; C22B 1/02; C22B 7/005; H01M 10/0525

(57) ABSTRACT

A method for recovering materials from a battery, such as a waste battery, with high purity and improved recovery efficiency.

### CROSS-REFERENCE TO RELATED APPLICATION

This present application claims the benefit of priority to Korean Patent Application No. 10-2025-0005119, filed on Jan. 14, 2025, in the Korean Intellectual Property Office, the entire disclosure of which is incorporated herein by reference.

### FIELD

The present disclosure relates to a method for recovering materials from batteries, and in particular materials from batteries.

### BACKGROUND

Efforts to achieve carbon neutrality are being intensified worldwide, resulting in a rapid increase in the demand and supply of electric vehicles. Consequently, the production of lithium-ion secondary batteries (LIB) has risen, and the volume of waste batteries has also grown significantly. Under these circumstances, the importance of waste battery recycling technology is increasingly coming into focus.

Due to the high energy density of the lithium-ion secondary battery, the lithium-ion secondary battery offers advantageous characteristics for miniaturization and lightweight applications, enabling its widespread use in various fields. In particular, the lithium-ion secondary battery plays a crucial role as an energy storage device for electric vehicles. The lithium-ion secondary battery typically includes a separator, a current collector, a cathode active material, an anode active material, and an electrolyte, among other materials. Depending on the type of cathode active material used, the lithium-ion secondary battery is classified into various types. Among them, the nickel-cobalt-manganese (NCM)-based cathode active material is widely used in South Korea due to its high energy density. This active material contains several valuable metals, including nickel (Ni), cobalt (Co), manganese (Mn), and lithium (Li). In particular, South Korea imports all of its nickel, a key component of the NCM-based cathode active material. Therefore, the development of recycling technologies for NCM-based waste batteries would provide great value and save resources.

Existing waste battery recycling technologies are generally conducted in a gas atmosphere containing carbon monoxide and carbon dioxide. During this process, environmentally harmful pollutants containing carbon are generated, leading to the loss of graphite, one of the primary components of waste batteries. Furthermore, the use of acids contaminates graphite, making its recycling difficult. As a result, additional processes are required to separate valuable metals and graphite.

Therefore, this disclosure addresses the need for an improved heat treatment technology to minimize pollution and graphite loss while efficiently separating the components of waste batteries.

### SUMMARY

In a general sense, the present disclosure is directed to providing a method for recovering materials with high purity from batteries.

In some embodiments, the present disclosure provides a method for recovering materials from batteries with improved efficiency.

In some embodiments, the present disclosure provides a method for recovering materials from batteries which can be applied to green technology such as, for example, the recycling of NCM-based batteries used in electric vehicles.

In one aspect, the present disclosure provides a method for recovering materials from lithium-ion batteries, the method including forming an atmosphere comprising hydrogen gas (or alternatively, a “hydrogen gas atmosphere”), heat-treating the lithium-ion batteries in the hydrogen gas atmosphere, and separating the heat-treated lithium-ion batteries by particle size.

The hydrogen gas according to some embodiments of the present disclosure may include hydrogen, or can comprise hydrogen and an inert gas.

The hydrogen gas according to some embodiments of the present disclosure may include hydrogen in an amount of at least 90 wt. % based on the total weight of the atmosphere comprising hydrogen gas.

The heat-treating according to some embodiments of the present disclosure may be performed at a temperature ranging from 800 to 1000° C.

By the heat-treating according the various aspects and embodiments of the present disclosure, at least one recovered material of nickel-cobalt alloy (Ni—Co), manganese oxide (MnO), lithium aluminate (LiAlO₂), lithium carbonate (Li₂CO₃), graphite (C), aluminum (Al), and copper (Cu) may be obtained.

In some embodiments, the separating according to the present disclosure may be performed using a plurality of separators, wherein the plurality of separators may include a first separator having a size of 5 to 25 mesh, a second separator having a size of 30 to 60 mesh, a third separator having a size of 75 to 200 mesh, and a fourth separator having a size of 300 to 1000 mesh.

In some embodiments, the lithium-ion battery according to the present disclosure may include at least one cathode active material of lithium nickel cobalt manganese oxide, lithium manganese oxide, nickel cobalt aluminum, and lithium cobalt oxide.

According to embodiments of the present disclosure, materials can be recovered with high purity from a lithium-ion battery.

According to further embodiments of the present disclosure, materials can be recovered with improved recovery efficiency.

The advantages and effects provided by the present disclosure are not limited to those identified above, and other advantages and effects that are not specifically mentioned herein are encompassed by the disclosure, which will be understood in light of the following description.

### BRIEF DESCRIPTION OF THE DRAWINGS

The foregoing and other aspects, features, and advantages of the invention, as well as the following detailed description of the embodiments, will be better understood when read in conjunction with the accompanying drawings. For the purpose of illustrating the present disclosure, there is shown in the drawings one or more exemplary embodiments, it being understood, however, that the present disclosure is not intended to be limited to the details shown because various modifications and structural changes may be made therein without departing from the spirit of the present disclosure and within the scope and range of equivalents of the claims. Like reference numbers and designations in the various drawings indicate like elements.

FIG. 1 depicts a schematic diagram of a method for recovering materials according to an embodiment of the present disclosure.

FIG. 2 depicts a flowchart illustrating a method for recovering materials according to an embodiment of the present disclosure.

FIG. 3 depicts XRD results for each particle size range of the recovered material according to Example 1 of the present disclosure.

FIG. 4 depicts XRD results for each particle size range of the recovered material according to Example 2 of the present disclosure.

FIG. 5 depicts XRD results for each particle size range of the recovered material according to Example 3 of the present disclosure.

FIG. 6 depicts experimental results that identified the mass distribution of each element as a function of the heat-treating temperature and particle size range in the method for recovering materials according to embodiments of the present disclosure.

FIG. 7 depicts experimental results that identified the purity for each particle size as a function of the heat-treating temperature conditions in the method for recovering materials according to embodiments of the present disclosure.

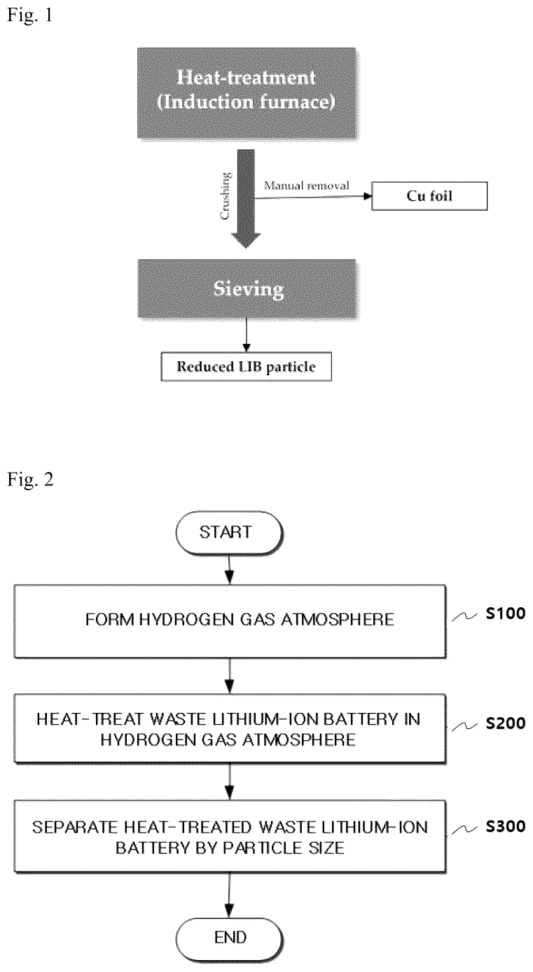

### DETAILED DESCRIPTION

The present disclosure will be described in further detail below with reference to exemplary embodiments. However, the following exemplary embodiments are provided merely as references for describing the present disclosure in further illustrative detail. The present disclosure is not intended to be limited to these particular details, and may be implemented in various forms.

Unless otherwise defined, all technical and scientific terms used herein have the same meaning as commonly understood by those skilled in the art to which the present disclosure pertains.

The terms used herein are intended merely to describe particular embodiments effectively and are not intended to limit the present disclosure.

Singular forms “a,” “an,” and “the” used in the specification and the appended claims are intended to include plural referents unless the context clearly dictates otherwise.

The units used in this specification, unless otherwise stated, are based on weight. For instance, the units such as “%” or “ratio” refer to weight percent (wt. %) or weight ratio, respectively. Unless otherwise defined, weight percent (wt. %) refers to the proportion of a specific component within the total composition, expressed as a percentage by weight.

When a portion is described as “including” or “comprising” a certain component, it means that, unless specifically stated to the contrary, the inclusion of other components is not excluded but rather that additional components may also be included. These terms are also understood to encompass terms that refer to embodiments that have “closed” language, for example “consisting of” and “consisting essentially of”, where such terms indicate that only the specifically recited features or elements are included, without additional components, or with only minor amounts of other components that do not have any substantial effect on the composition or method.

In addition, numerical ranges used in this specification may include all values between the lower and upper limits, all values incrementally derived logically within shape and breadth of the defined ranges, all double-limited values, and all possible combinations of upper and lower limits of differently limited numerical ranges. Unless specifically defined in this specification, values outside the defined numerical ranges that may occur due to experimental error or rounding off of values are also included within the defined numerical ranges.

In an aspect, the disclosure provides a method for recovering materials from a battery, and in some example embodiments, a material from a lithium-ion waste battery. In some embodiments, the present disclosure relates to a method for recovering materials from a lithium-ion battery, the method including providing or forming an atmosphere comprising hydrogen gas (or alternatively, a “hydrogen gas atmosphere”), heat-treating the lithium-ion battery in the hydrogen gas atmosphere, and separating the heat-treated lithium-ion battery by particle size. The method for recovering materials from the lithium-ion battery enables the high-purity and high-efficiency recovery of materials from the lithium-ion battery through the organic combination of gas types, heat-treating conditions, and separation conditions. Accordingly, in some aspects the disclosure provides a high purity recovered material that is produced by the methods described herein.

In some embodiments, the providing or forming the hydrogen gas atmosphere (S100) includes forming an environment inside a device in which the heat treating is performed, such as a furnace, such that hydrogen gas becomes the main component present, instead of air, and specifically, forming an environment in which hydrogen gas constitutes 90 vol % or more, 95 vol % or more, or 99.9 vol % or more of the total gas composition. In embodiments, the hydrogen gas atmosphere provides a strong reduction power and a fast reaction rate for the materials contained in the lithium-ion batteries during heat treatment. As a result, it can effectively induce the reduction of the materials at lower temperature while minimizing pollution.

In one embodiment of the present disclosure, the furnace may include a vertical firing furnace with a plurality of working sections. For example, in some embodiments the vertical firing furnace may be configured with an upper working section and a lower working section, each of which can be independently controlled. In some embodiments, the upper working section may be responsible for preheating lithium-ion battery, while the lower working section may perform the main heat-treating process. In some further embodiments, each working section is equipped with a gas supply unit and a gas discharge unit. In such embodiments, the gas supply unit can be configured to deliver an atmosphere comprising hydrogen gas, while the gas discharge unit can be configured to ensure the safe discharge of any used gas.

In one embodiment of the present disclosure, the furnace has a vertical firing furnace structure, which configuration can enable a continuous and uniform heat-treating process by, for example, moving a storage unit containing lithium-ion batteries in the vertical direction. In embodiments, he storage unit is sequentially heated by the heating sections of the furnace, during which hydrogen gas atmosphere (i.e., including hydrogen) may be supplied into the working section. Such a configuration can ensure that heat can be uniformly and efficiently transferred to the lithium-ion batteries. In additional embodiments, the vertical firing furnace structure can help to optimize the flow of gases generated during the heat treatment process, enabling uniform heating of lithium-ion batteries and maximizing the efficiency of the heat treatment.

In embodiments, the gas supply unit supplies hydrogen gas (i.e., an atmosphere including hydrogen gas) into the working sections, while the gas discharge unit safely discharges the used gas, thereby maintaining optimal conditions within the working sections.

In one embodiment of the present disclosure, the furnace may include one or a plurality of heating units, which can be provided in a plurality corresponding to each working section. In embodiments, each heating section may be controlled depending on the measured temperature of its corresponding working section to ensure the target temperature in the section is maintained. In such configuration, the working sections of the furnace can precisely maintain various heat-treating conditions, enabling the effective reduction of lithium-ion batteries and the recovery of materials.

In one embodiment of the present disclosure, the atmosphere comprising hydrogen gas may include hydrogen, or it can comprise hydrogen and an additional gas such as, for example, an inert gas.

In one embodiment of the present disclosure, the inert gas may include at least one of argon (Ar), helium (He), neon (Ne), krypton (Kr), xenon (Xe), radon (Rn), and nitrogen (N₂), and in some specific embodiments, may include argon.

In some embodiments of the present disclosure, the atmosphere comprising hydrogen gas may include hydrogen in an amount of at least 90 wt. % based on the total weight of the atmosphere comprising hydrogen gas. Specifically, the hydrogen gas atmosphere may include hydrogen in an amount of at least 90 wt. %, 92 wt. %, 94 wt. %, 96 wt. %, 98 wt. %, or 99 wt. % based on the total weight of the hydrogen gas atmosphere, and up to 100 wt. %. (i.e., “consists of” or “consists essentially of” hydrogen gas). In embodiments that provide the above range, the reduction reaction may be easier to perform and enable efficient separation. In some specific embodiments, wherein the hydrogen gas includes 100 wt. % hydrogen, improved results can be achieved. In accordance with embodiments wherein the hydrogen content is less than 100 wt. %, the remaining portion of the atmosphere may comprise, or consist of, the inert gas.

In some embodiments, heat-treating the lithium-ion battery in the hydrogen gas atmosphere (S200) may include reducing the materials contained in the lithium-ion battery by heat-treating the lithium-ion battery in a device where the hydrogen gas atmosphere is formed.

In one embodiment of the present disclosure, the heat-treating may be performed at a lower temperature limit of at least 800° C., 900° C., 950° C., or 1000° C., and an upper temperature limit of up to 1500° C., 1200° C., or 1100° C. In embodiments wherein this condition is satisfied, the reduction reaction may proceed efficiently, leading to an improvement in the recovery rate of materials.

In one embodiment of the present disclosure, the method can provide at least one recovered material such as, for example, nickel-cobalt alloy (Ni—Co), manganese oxide (MnO), lithium aluminate (LiAlO₂), lithium carbonate (Li₂CO₃), graphite (C), aluminum (Al), and copper (Cu), any of which may be obtained by the heat-treating process. However, the material obtained is not limited to only these materials.

In embodiments, the separating the heat-treated lithium-ion battery by particle size (S300) may include separating the materials reduced through the heat-treating using a separator.

In one embodiment of the present disclosure, the separating may be performed using a plurality of separators. In some specific embodiments, the number of separators may range from 4 to 6, but is not necessarily limited thereto. For example, the number of separators may vary depending on the types of materials to be reduced. By using multiple separators, particles of various sizes can be effectively separated, allowing materials to be selectively recovered with high purity.

In one embodiment of the present disclosure, the plurality of separators may include a first separator having a size of 5 to 25 mesh, specifically 10 to 23 mesh, more specifically 15 to 20 mesh, a second separator having a size of 30 to 60 mesh, specifically 32 to 50 mesh, more specifically 34 to 40 mesh, a third separator having a size of 75 to 200 mesh, specifically 85 to 150 mesh, more specifically 95 to 120 mesh, and a fourth separator having a size of 300 to 1000 mesh, specifically 400 to 800 mesh, more specifically 450 to 600 mesh.

In embodiments, the separating the heat-treated lithium-ion battery by particle size may include crushing the heat-treated lithium-ion battery to improve separation efficiency, followed by separation based on particle size. The crushing method is not particularly limited and can include any method known to those skilled in the art; however, in some embodiments mechanical crushing methods such as ball milling and friction processes may be used.

In one embodiment of the present disclosure, the lithium-ion battery may include at least one cathode active material including lithium nickel cobalt manganese oxide, lithium manganese oxide, nickel cobalt aluminum, and/or lithium cobalt oxide.

In one embodiment of the present disclosure, the method for recovering materials from the lithium-ion battery may further include pretreating the lithium-ion battery, and crushing the pretreated lithium-ion battery.

In embodiments, the pretreating the lithium-ion battery can be performed for explosion prevention, hazard neutralization, and external casing removal of the lithium-ion battery. In some specific embodiments, since lithium-ion batteries, such as used lithium-ion batteries, are sealed systems containing electrolytes and other components inside, crushing the lithium-ion batteries in their original state creates a risk of explosion. Therefore, it is typically necessary to perform discharge treatment or removal of the electrolyte. As such, by removing the electrolyte and the outer casing in the pretreatment process of the batteries, it is possible to enhance the safety of the process and improve the recovery productivity of valuable metals such as copper, nickel, and cobalt. In some embodiments, the discharge treatment can be performed by immersing the battery in an aqueous solution containing alkali metal or alkaline earth metal ions.

In embodiments comprising the crushing of the pretreated lithium-ion battery, typically contents of the battery are crushed to obtain a crushed material. The crushing can be carried out to improve the recovery rate of valuable metals such as copper, nickel, and cobalt by enhancing the reaction efficiency in subsequent processes. The crushing method is not particularly limited, for example, it can be carried out by crushing or cutting the battery contents using existing crushers, such as a cutter mixer or any other suitable methods generally known in the art.

In one embodiment of the present disclosure, the lithium-ion battery may comprise a waste lithium-ion battery.

In one embodiment of the present disclosure, the waste lithium-ion battery may refer to a lithium-ion battery that has reached the end of its useful life, is no longer suitable for its original intended purpose, and is subject to recycling, disposal, or resource recovery processes.

In addition, embodiments of the present disclosure may provide a material recovered by the method for recovering materials from a lithium-ion battery.

Hereinafter, some illustrative and various embodiments of the present disclosure will be described. However, the following embodiments are merely exemplary embodiments of the present disclosure, and the present disclosure is not intended to be limited thereto.

### Example 1

Pretreatment was carried out by immersing the waste lithium-ion battery containing lithium nickel cobalt manganese oxide as a cathode active material in an aqueous solution containing alkaline earth metal ions and discharging it for 24 hours. Subsequently, a crushing process was carried out through a crushing or cutting operation to ensure smooth feeding into a furnace. Next, a hydrogen gas atmosphere, having 100% wt. % hydrogen, was introduced into the interior of a furnace in which the crushed material was contained. The recovered material was then obtained from the waste lithium-ion battery through the heat treatment at 800° C. for 15 minutes. Finally, the recovered material was sieved using four separators with sizes of 18 mesh (1 mm), 35 mesh (500 μm), 100 mesh (150 μm), and 500 mesh (25 μm), respectively.

### Example 2

Example 2 was carried out in the same manner as in Example 1, except for performing the heat treatment at a temperature of 900° C. for 15 minutes.

### Example 3

Example 3 was carried out in the same manner as in Example 1, except for performing the heat treatment at a temperature of 1000° C. for 15 minutes.

### Experimental Example 1: Composition Analysis of Recovered Material

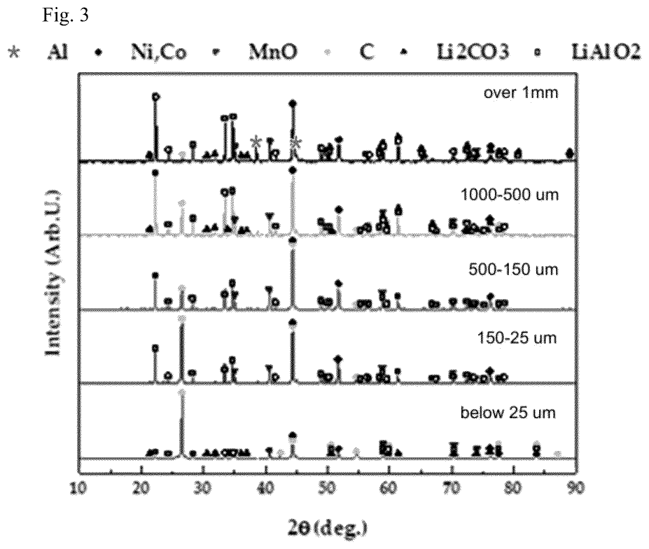

To analyze the composition of the recovered material obtained according to the Examples of the present disclosure, X-ray Diffraction (XRD) analysis was performed. Specifically, after removing copper foil through particle size separation, XRD analysis was performed exclusively on the recovered material in powder form, and the results are shown in FIGS. 3 to 5.

As shown in FIG. 3, nickel-cobalt alloy (Ni—Co), manganese oxide (MnO), lithium aluminate (LiAlO₂), lithium carbonate (Li₂CO₃), graphite (C), and aluminum (Al) were identified from the recovered material of Example 1 across five particle size ranges. Specifically, the phase of aluminum (Al) was identified in the particle size range of 18 mesh or smaller, but it was not detected in the remaining particle size ranges. This indicates that Al can be selectively recovered from the recovered material using a separator having a size of 18 mesh. However, as phases other than Al were also present in this particle size range, obtaining high-purity Al was challenging. In the other particle size ranges, various compounds are mixed, making it evident that separating the components can be difficult.

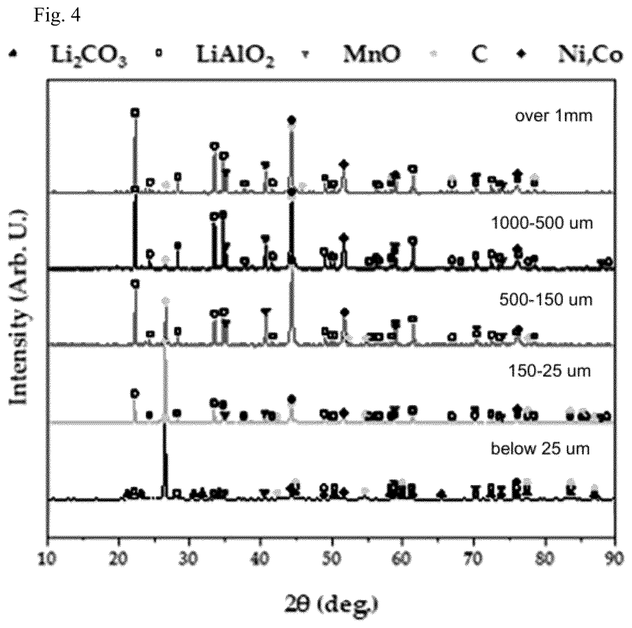

As shown in FIG. 4, nickel-cobalt alloy (Ni—Co), manganese oxide (MnO), lithium aluminate (LiAlO₂), lithium carbonate (Li₂CO₃), and graphite (C) were identified from the recovered material of Example 2. In the particle size range of 500 mesh or more, the phase of lithium carbonate (Li₂CO₃) was identified, whereas it was not detected in the other particle size ranges. This indicates that Li₂CO₃ can be selectively recovered from the recovered material using a separator having a size of 500 mesh. However, as phases of various compounds other than Li₂CO₃ are mixed within this particle size range, obtaining high-purity Li₂CO₃ was challenging. In the other particle size ranges, various compounds are mixed, making it evident that separating the components can be difficult.

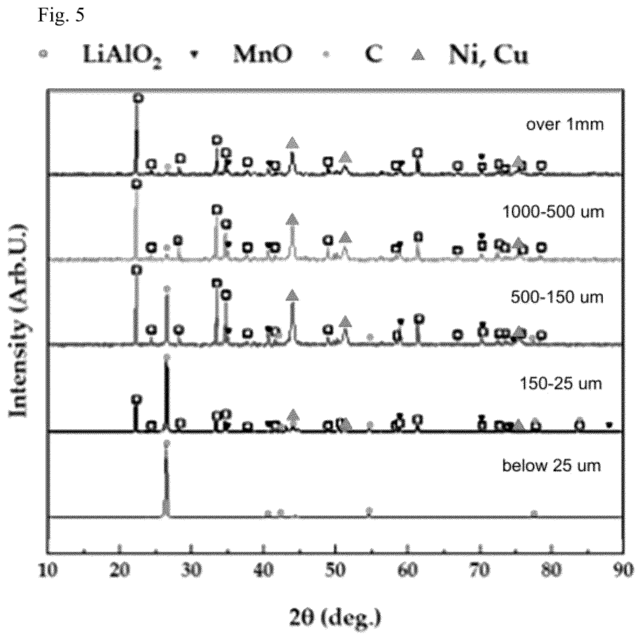

As shown in FIG. 5, Nickel-copper alloy (Ni—Cu), manganese oxide (MnO), lithium aluminate (LiAlO₂), and graphite (C) were identified from the recovered material of Example 3. Notably, in the particle size range of 500 mesh or more, only the phase of graphite (C) was present, indicating that high-purity graphite (C) can be selectively recovered.

### Experimental Example 2: Mass Analysis for Each Element Based on Temperature and Particle Size

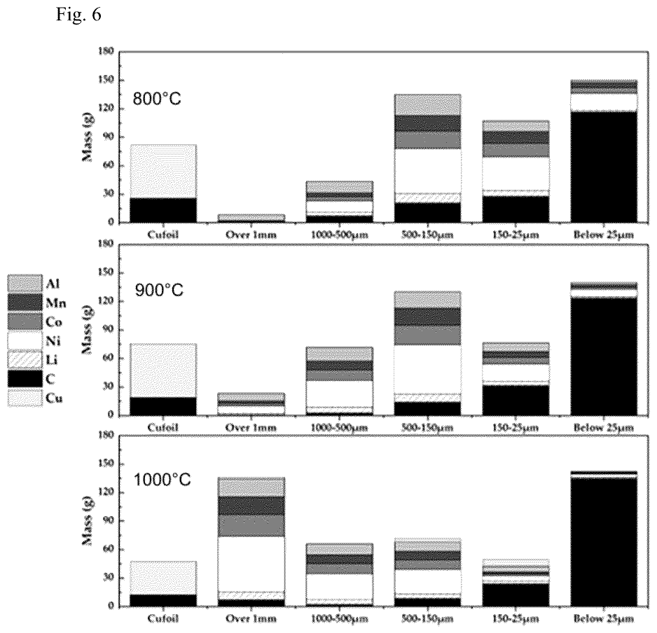

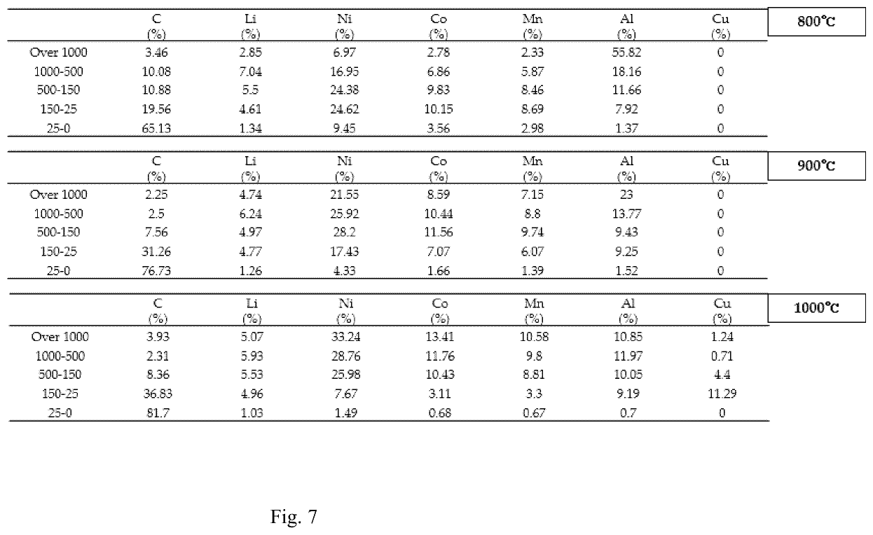

To identify the mass distribution of each element based on temperature and particle size in the recovered material obtained from the Examples of the present disclosure, heat treatment was performed under each temperature condition, followed by particle size separation and elemental analysis for each particle size range. FIGS. 6 and 7 show the results.

FIG. 6 illustrates the mass distribution of each element across a total of six particle size ranges, including copper foil and the recovered material in powder form. It was identified that the mass distribution of Ni became more concentrated in larger particle size ranges as the heat treatment temperature increased. Co was identified to exist in the same particle size ranges and at the same ratio as Ni, as it is present in the form of an alloy with Ni. It was identified that the mass distribution of Mn also became more concentrated in larger particle size ranges as the heat treatment temperature increased. It was identified that as the heat treatment temperature increased, the mass distribution of C became more concentrated in smaller particle size ranges and also showed a tendency to concentrate in specific particle size ranges, particularly 500 mesh or more. Through the above Examples, it was confirmed that the particle size distribution of key materials such as Ni, Co, Mn, and C can be controlled by adjusting the heat treatment temperature in the heat treatment process using hydrogen-containing gas, and subsequently, selective recovery of high-purity C can be achieved through particle size separation.

As shown in FIG. 7, the purity of graphite (C) is highest in the particle size range above 500 mesh, reaching a maximum of 81.7% at 1000° C. This indicates that the heat treatment at 1000° C. is the most suitable condition for recovering high-purity graphite (C).

These results indicate that the heat treatment process at 1000° C. or higher in a hydrogen gas atmosphere consisting of 100 wt. % hydrogen maximizes the reduction and separation efficiency of materials contained in NCM waste batteries, and particularly enables the selective recovery of high-purity graphite (C). This high-purity graphite (C) can serve as a highly suitable raw material for the subsequent hydrometallurgical process, improving the efficiency of hydrometallurgy and contributing to minimizing the environmental impact associated with the recycling process.

The features, structures, effects, and the like described in the exemplary embodiments above are included in at least one embodiment of the present disclosure and are not necessarily limited to a single embodiment. Furthermore, the features, structures, effects, and the like exemplified in each exemplary embodiment can be combined or modified in other embodiments by those skilled in the art to which the embodiments pertain. Therefore, such combinations and modifications should be construed as being within the scope of the present disclosure.

What is claimed is:

1. A method for recovering materials from a lithium-ion battery, comprising:
providing an atmosphere comprising hydrogen gas;
heat-treating the lithium-ion battery in the atmosphere; and
separating the heat-treated lithium-ion battery by particle size.

2. The method according to claim 1, wherein the atmosphere comprising hydrogen gas further comprises an inert gas.

3. The method according to claim 2, wherein the atmosphere comprising hydrogen gas comprises hydrogen in an amount of at least 90 wt. % based on the total weight of the atmosphere.

4. The method according to claim 1, wherein the heat-treating is performed at a temperature ranging from 800° C. to 1000°C.

5. The method according to claim 1, wherein at least one recovered material comprises nickel-cobalt alloy (Ni—Co), manganese oxide (MnO), lithium aluminate (LiAlO₂), lithium carbonate (Li₂CO₃), graphite (C), aluminum (Al), and/or copper (Cu).

6. The method according to claim 1, wherein the separating is performed using a plurality of separators, and the plurality of separators comprises a first separator having a size of 5 to 25 mesh, a second separator having a size of 30 to 60 mesh, a third separator having a size of 75 to 200 mesh, and a fourth separator having a size of 300 to 1000 mesh.

7. The method according to claim 1, wherein the separating is performed using a plurality of separators, and the plurality of separators comprises a first separator having a size of 10 to 23 mesh, a second separator having a size of 32 to 50 mesh, a third separator having a size of 85 to 150 mesh, and a fourth separator having a size of 400 to 800 mesh.

8. The method according to claim 1, wherein the separating is performed using a plurality of separators, and the plurality of separators comprises a first separator having a size of 15 to 20 mesh, a second separator having a size of 34 to 40 mesh, a third separator having a size of 95 to 120 mesh, and a fourth separator having a size of 450 to 600 mesh.

9. The method according to claim 1, wherein the lithium-ion battery comprises at least one cathode active material comprising lithium nickel cobalt manganese oxide, lithium manganese oxide, nickel cobalt aluminum, and/or lithium cobalt oxide.

10. The method according to claim 1, wherein the lithium-ion battery comprises a waste lithium-ion battery.

11. A material recovered by the method for recovering materials from a lithium-ion battery according to claim 1.
